(19) United States
(12) Patent Application Publication
(10) Pub. No.: US 2007/0211734 A1
(43) Pub. Date: Sep. 13, 2007

(54) DIGITAL LIVING NETWORK ALLIANCE GATEWAY HAVING INTEGRATED WEBSITE SERVER FOR REMOTE ACCESS AND METHOD THEREOF

(76) Inventors: Kuo-Long Yang, Taichung County (TW); Su-Fang Ku, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/308,182

(22) Filed: Mar. 10, 2006

(51) Int. Cl. H04L 12/56; H04L 12/28

(52) U.S. Cl. 370/401

(57) ABSTRACT

A network gateway includes a first port being coupled to an external network connection; a web server module being coupled to the first port for serving web pages to a remote user through the external network connection; a digital living network alliance (DLNA) controller being coupled to the web server module; and a second port being coupled to the digital living network alliance (DLNA) controller and a digital living network alliance (DLNA) compatible internal network; wherein the digital living network alliance (DLNA) controller is for controlling a digital living network alliance (DLNA) compatible peripheral device being coupled to the network gateway utilizing the second port according to commands received from the remote user.

### BACKGROUND OF THE INVENTION

1. Field of the Invention

The invention relates to network gateways, and more particularly, to a network gateway having an integrated web page server for access through the Internet or another network to control digital living network alliance (DLNA) compatible devices coupled thereto.

2. Description of the Prior Art

The Digital Living Network Alliance (DLNA) is an alliance of leading companies in the consumer electronics, mobile and personal computer industries. Its aim is to align the companies and have industry standards, which will allow products from all companies to be compatible with each other. By making a wired and wireless interoperable network where digital content such as music, photos, and videos can be seamlessly shared through personal computers (PCs), consumer electronics (CE) and mobile devices in and beyond the home, cross-industry convergence will be enabled by establishing a platform of interoperability based on open and established industry standards. In this way consumers will be able to enjoy digital living easily and seamlessly. Companies, under the alliance are still free to innovate and differentiate their own products.

To achieve this goal, there are several committees under DLNA working to produce standards for different functions. It is important for DLNA to address current and future use case scenarios and their role in developing design guidelines for interoperable products. The “Use Case Subcommittee” is a committee, which offers detailed information on organization's evaluation of the most common, near-term consumer use models for digital products. In this way, members in the organization can come out a standard from user's point of view, instead of only from the technology's (i.e., designer's) point of view.

The following figures and description describe use-scenario examples from DLNA “Use Case Subcommittee” that explorer various desired remote network functions.

FIG. 1 shows an example scenario of downloading pictures to a smart phone 100 according to the DLNA “Use Case Subcommittee”. In this example, a user is out for travel and wants to see a snapshot of his home to make sure things at home are without problem. The user logs in to his home network over a secure link, and uses the user interface (UI) on his mobile phone 100 to activate his PC 102 and browse the snapshots by time order. A particular snapshot is selected, and the smart phone 100 downloads this picture from the PC 102 for display. Assumptions that apply to the scenario include:
User can log in to home network from “outside” and authenticate to allow access to media stored on PC 102.
The user has a handheld device (a mobile AV player) that is either a standalone device linked to the mobile phone 100 or is a function provided by their mobile phone 100.
The user has a PC 102 serving as the home gateway in the home network.
The user has a digital camera 104 attached to the PC 102 and controlled by the PC 102 to download photos on schedule and transfer photos back to the PC 102.
The mobile phone device 100 is able to connect to the Internet via GPRS or CDMA network.

FIG. 2 shows an example scenario of performing remote access media transfers according to the DLNA “Use Case Subcommittee”. For example, assume that some friends are out to dinner together looking at pictures on their portable devices 200, 202. They find that the cell phone 200 does not contain all of the pictures that they thought. The owner of the cell phone 200 connects the cell phone 200 to the General Packet Radio Service (GPRS) network. To call home, the user clicks on the icon having the name HOME on the handheld 200. The selected application will connect with the home gateway 204 using information that is has obtained such as the uniform resource locator (URL) that points to a public IP address maintained by the local ISP. The HOME application connects with the home gateway 204 and establishes a secure channel. The device 200 now sees all of the DLNA media devices 206 within the home. Once connected to the home network, the user can perform any media operation that she can do when she is home. In this case, the user browses the media server 206 and selects the missing pictures for download to the cell phone 200 over the GPRS network. Additionally, pictures taking during the dinner with her friends can be uploaded to her home media server 206 for safe storage. Assumptions that apply to the scenario include:
User has a portable device 200, 202 that they would like to use to play or capture media.
User has configured remote access of their home with authentication performed by a home gateway 204.
User has a number of media devices such as a digital media server (DMS) 206 within the home.
The portable device being utilized for playback 202 connects to the home network via a public internet network (802.11, 802.3, or GPS/3G network).
The home gateway is addressable from the external network 208.

FIG. 3 shows an example scenario of remote access for any device that roams (e.g., Internet gateway device (IGD), or server) according to the DLNA “Use Case Subcommittee”. In this example, a user takes a picture with a digital camera 300 at a location such as a coffee shop with a wireless hotspot. The user selects pictures to save, and the camera 300 connects to a server 302 at the user's home. The selected pictures are saved on the home server 302, and the user's family and friends 304 can now remotely connect to the media server 302 and see the new pictures. Assumptions that apply to the scenario include:
The digital camera 300 is associated with server 302 on the local area network (LAN).
The LAN, port mapping, and DNS registration are properly setup.
Some kind of a DNS based service is available.
The camera 300 has Wi-Fi support or another network interface that provides internet connectivity.
The camera 300, and family & friends 304 can have different access permissions to the service running on the server 302.
The users family and friends 304 have been granted remote access to portions of the media server 302.

FIG. 4 shows an example scenario of remote access (i.e., remote transfer and control of home media) according to the DLNA “Use Case Subcommittee”. In this example, a first user has a music file A.mp3 on his home PC 440 and wants to share the music with a second user. The first user connects to the home gateway 410 of the second user, which pre-authorizes his mobile phone 420 as a guest. The second users's home stereo system 400 is among the devices available and allowed for the first user's phone to access. The first user logs into his own home network 430 and uses his mobile phone 420 (i.e, the control point) to select to play the music file A.mp3 from his PC 440 to an application (DMP) on his phone 420. The application (DMP with forwarding) forwards the media stream to the home stereo system 400 of the second user via his mobile phone 420. The music can then be played on the home stereo system 400 of the second user. Assumptions that apply to the scenario include:
A GPRS or 3G network and network ready mobile device (mobile phone 420) are available to allow browsing, controlling and transferring home media data to a remote rendering device via the GPRS/3G network.
Mobile phone 420 has WiFi or Bluetooth capabilities.
The content downloaded are either made personally available or are freely available on the internet (i.e. no digital rights management (DRM) issues), if DLNA decides to implement DRM, then the techniques may be used in this use case (no special standard or technology is needed).

However, not described by the above user scenarios by the DLNA subcommittee are several problematic issues. For example, sometimes in the DLNA description, the user experience steps are greatly simplified to make the scenario look easy. However, in doing this, critical and non-obvious steps are thereby omitted. That is, some information that is required is missing. Take the step “Connect to home gateway device” as an example. It is not clear how does a remote user actually locate his or her “home”? Another example is what role will home internet gateway play in remote access. That is, does the technology used a virtual private network (VPN) or a browser technology such as SSH/SSL? Issues such as the details for port redirect are also omitted.

### SUMMARY OF THE INVENTION

One objective of the claimed invention is therefore to provide a digital living network alliance compatible gateway having integrated website server for remote access, to thereby solve the above-mentioned problems.

According to an exemplary embodiment of the claimed invention, a network gateway is disclosed comprising a first port being coupled to an external network connection; a web server module being coupled to the first port for serving web pages to a remote user through the external network connection; a digital living network alliance (DLNA) controller being coupled to the web server module; and a second port being coupled to the digital living network alliance (DLNA) controller and a digital living network alliance (DLNA) compatible internal network; wherein the digital living network alliance (DLNA) controller is for controlling a digital living network alliance (DLNA) compatible peripheral device being coupled to the network gateway utilizing the second port according to commands received from the remote user.

According to another exemplary embodiment of the claimed invention, a method is disclosed for accessing a digital living network alliance (DLNA) compatible peripheral device from a remote network, the method comprising serving web pages to a remote user through an external network connection utilizing a web server module; controlling the digital living network alliance (DLNA) compatible peripheral device according to commands received from the remote user via the web pages served to the remote user; and passing a status of the digital living network alliance (DLNA) compatible peripheral device to the web server module for transfer to the remote user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an example scenario of downloading pictures to a smart phone according to the related art.

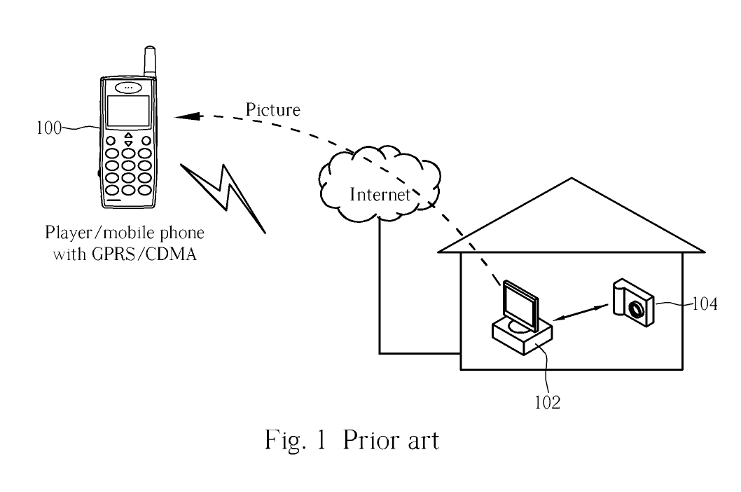

FIG. 2 shows an example scenario of performing remote access media transfers according to the related art.

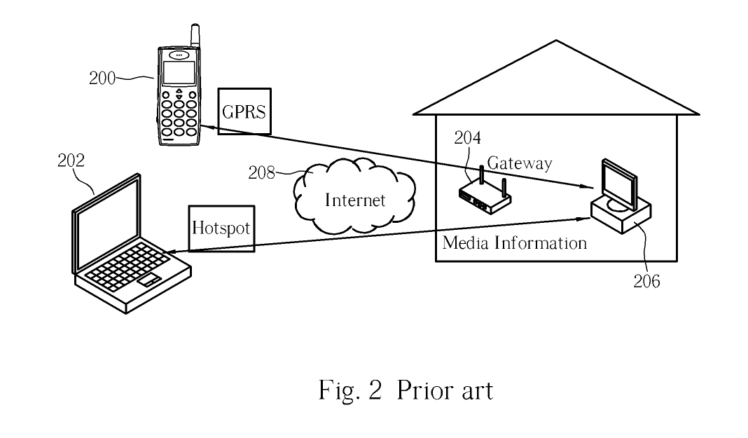

FIG. 3 shows an example scenario of remote access for any device that roams such as an Internet gateway device or server according to the related art.

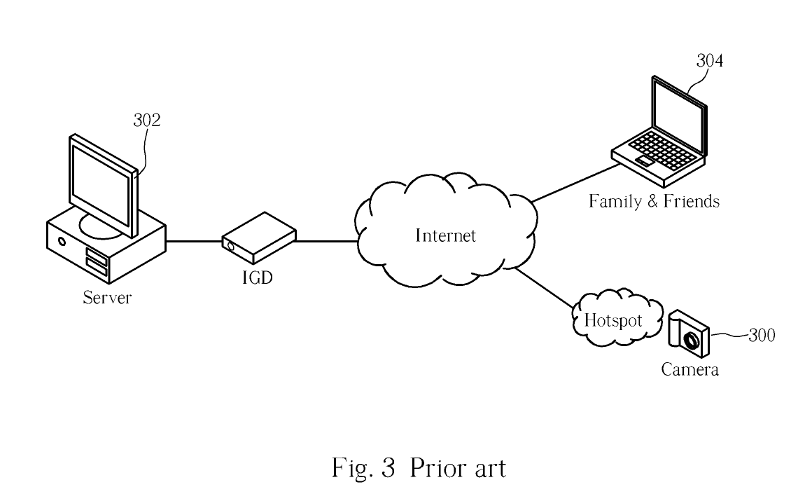

FIG. 4 shows an example scenario of remote access such as a remote transfer and control of home media according to the related art.

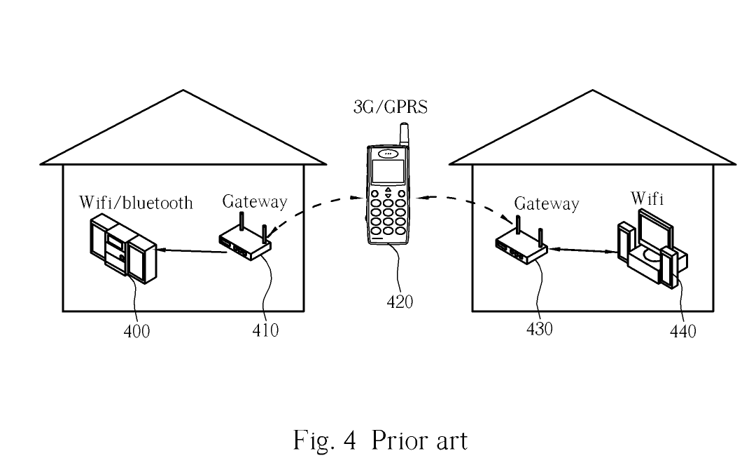

FIG. 5 shows a network gateway according to an exemplary embodiment of the present invention.

FIG. 6 shows an example of the web based home device control menu generated by the web server and presented to the user according to an exemplary embodiment of the present invention.

FIG. 7 shows a flowchart describing a method of accessing a digital living network alliance (DLNA) compatible peripheral device from a remote network according to an exemplary embodiment of the present invention.

### DETAILED DESCRIPTION

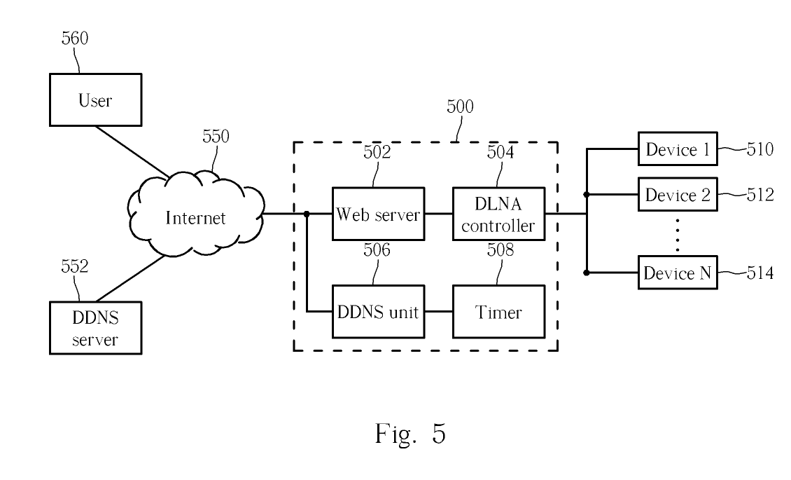

FIG. 5 shows a network gateway 500 according to an exemplary embodiment of the present invention. The network gateway 500 acts as a digital home service directory and allows a user 560 to access a plurality of Digital Living Network Alliance (DLNA) compatible peripheral devices 510, 512, 514 in his or her home from anywhere on the Internet 550. As shown in FIG. 5, in this embodiment, the network gateway 500 includes a web server 502, a DLNA controller 504, a dynamic domain name service (DDNS) unit 506, and a timer 508. The home network gateway 500 is connected to the Internet 550 by such means as a modem, a cable modem, an asynchronous digital subscriber line (ADSL), or any other connection means that allows network connectivity. When using dynamic internet protocol (IP) address, at the time of establishment with the Internet 550, the home network 500 will be assigned an available internet protocol (IP) address. This so-called “dynamic IP address” may also change during the connection with the Internet 550. Alternatively, the same static IP address may be assigned to the home gateway 500 each time it establishes a connection with the Internet 550 and will not vary during usage.

To allow the user 560 to easily access the DLNA compatible devices 510, 512, 514, the web server 502 of the network gateway 500 acts as a web site for the user 560 to access and thereby view the status of and send commands to the devices 510, 512, 514. The web server also performs user authentication to ensure the user 560 has the proper permissions to access each of the devices 510, 512, 514. For example, the web server 502 will require a username and password from the user 560 before allowing access to the control menu for the devices. In another embodiment, the web server 502 will also contain a list of usernames and corresponding passwords to allow different permissions for different users.

By enabling the web site service of the web server 502, a particular transport carrier packet (TCP) port (i.e., port 80) of the network gateway 500 on the wide area network (WAN) side is opened. That is, on the side of the network gateway 500 coupled to the Internet 550. Once enabled, the gateway 500 sends a broadcast message to query for all available services in the home network. That is, the gateway 500 searches for all available DLNA devices 510, 512, 514. After the query, all services are organized in one web page with links to the services and statuses for the services shown. A remote user 560 can browse the service directory web page on port 80, for example, to find a list of services that have discovered by the gateway 500. Each of these services can be accessed via the web page and statuses of the services can also be viewed on the web page.

When a user 560 is away from their home and wants to access one of the services provided by a device (i.e., one of the devices 510, 512, 514) in their home, the user 560 simply needs to open a browser and point the browser to his home domain name URL (or IP address if known). The connection is opened, and a login page is shown. The user 560 enters the authentication information, and assuming the authentication information is correct, a service directory web page is shown on the user's 560 browser. The user 560 clicks the link to the service he wants to access and, in one embodiment, through a port redirect mechanism provided by gateway 500 the user 560 is able to access the appliance service in his home network. Additionally, in another embodiment, the gateway 500 can act as a remote access proxy instead of a port redirect. In this embodiment, the user 560 directly performs the control of the devices 510, 512, 514 on the web page or directly views the statuses of the devices 510, 512, 514 on the web page.

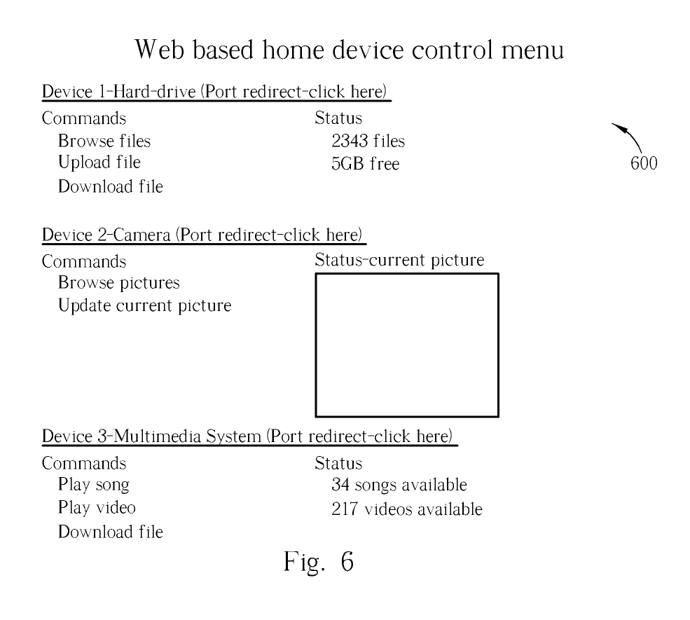

FIG. 6 shows an example of the web based home device control menu 600 generated by the web server 502 and presented to the user according to an exemplary embodiment of the present invention. In this example, the first device 510 corresponds to a DLNA enabled hard disk drive, the second device 512 corresponds to a DLNA enabled camera, and the Nth device 514 corresponds to a DLNA enabled multimedia system. However, it should be noted that these are simply examples provided for illustrative purposes. As will be apparent to a person of ordinary skill in the art after having read this disclosure, any number of different DLNA enabled peripheral devices can be coupled to the network gateway 500 for remote control by the user 560.

User authentication is performed by the web server 502 and the traffic can be encrypted using standard https, which is a well known scheme equivalent to the http scheme, originally intended to be used with the HTTP protocol, but with added encryption layer. The scheme also provides for authentication and encrypted communication and is widely used on the Web for security-sensitive communication, such as payment transactions. Instead of using plain text socket communication, the session data is encrypted using either a version of the SSL (Secure Socket Layer) protocol or the TLS (Transport Layer Security) protocol, thus ensuring reasonable protection from eavesdroppers, and man in the middle attacks.

As shown in FIG. 6, after logging in to the gateway 500 with a proper username and password, the user 560 is presented with a web page allowing access of the devices 510, 512, 514. When utilizing a port redirect mode, the user simply needs to click the title name of the device and the web server 502 will perform a port redirect to allow the user to access a chosen DLNA enabled device. The port redirect function is already well understood in the related art and further explanation of how to technically implement the port redirect is therefore omitted herein for the sake of brevity. Alternatively, when operating as an access proxy, the user 560 sees the current status of these devices 510, 512, 514 (if available) directly on the web page 600. For example, statistics on the hard disk drive 510 and a current picture taken by the camera 512 are included on the web based home device control menu 600 generated by the web server 502 as shown in FIG. 6.

The DLNA controller 504 of FIG. 5 performs the specific command controls, handshaking, and status reading of each of the devices 510, 512, 514. Additionally, the DLNA controller 504 monitors for any new DLNA devices that may be added or turned at a later time. If a new DLNA device comes online, the DLNA controller 504 informs the web server 502, and the new device is added to the web based home device control menu 600 generated by the web server 502. In this way, if a new device is coupled to the home gateway 500 (or has it's power turned on, etc), the user 560 will then be able to check the status and send commands for the new device via the web server 502. The protocol followed by the DLNA controller 504 complies with the DLNA standard and in this way any DLNA compatible device can be controlled by the user 560 from anywhere on the Internet. The only requirement may be specific firmware or updates to the web server 502 to include all the required functions for each possible device 510, 512, 514. For example, as shown in FIG. 6, if one of the possible devices is a camera 512, then the web server 502 should have the capability to generate a web page 600 displaying a picture from the camera 512. The ability to play movies or audio files, or to perform other device specific tasks can also be optionally included in the web server 502.

In order to allow the user 560 to always be able to find his or her network gateway 500 from anywhere on the network 550, the DDNS unit 506 works in conjunction with the timer 508 to periodically check if the IP address of the gateway 500 has been changed. For example, as previously mentioned, in the event of a dynamic IP address (which is very common for dial-up and other home based internet connections), each time the DDNS unit 506 detects a new IP address, it will report the new IP address to a DDNS server 552 on the Internet 552. In this way, the user 560 only needs to remember a uniform resource locator (URL) such as www.myhome.com. This URL will be looked up in the DDNS server 552 and the current IP address of the gateway 500 will be utilized for connection by the user 560 to the gateway 500. The user 560 can then view the web pages 600 generated by the web server 502 with any portable device or another device that is connected to the Internet and includes a web browser. In this way, the user 560 does not need to know the current IP address of his home in order to log into the gateway 500 and control and view the status of DLNA compatible devices 510, 512, 514 coupled to the gateway 500.

In one embodiment, the web server 502 is implemented in hardware with user changeable parameters being stored in firmware. This allows the gateway 500 to be connected to the Internet 552 provided by a Internet service provider utilizing a first port, and to have a plurality of second ports that are DLNA compatible and coupled to a corresponding plurality of DLNA peripheral devices. That is, a user can control the DLNA peripheral devices from anywhere on the Internet from any device that supports web browsing capabilities. Because the web server is implemented in hardware, the security of the gateway 500 web server 502 is enhanced. This is because the web server 502 is dedicated to the single task of providing remote access and will not include other less secure features or be susceptible to computer viruses, etc. It should also be mentioned that other networks other than the Internet 550 could also be utilized with the present invention such as private local area networks (LANs) or company intranet networks.

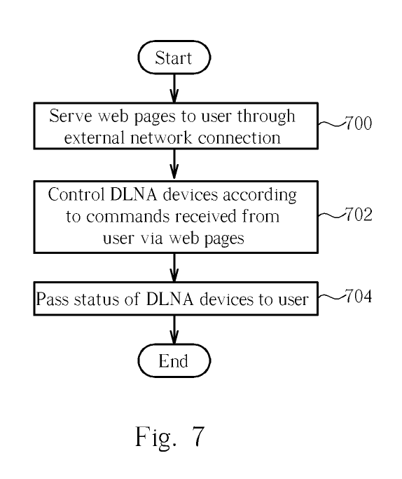

FIG. 7 shows a flowchart describing a method of accessing a digital living network alliance (DLNA) compatible peripheral device from a remote network according to an exemplary embodiment of the present invention. Provided that substantially the same result is achieved, the steps of the flowchart of FIG. 7 need not be in the exact order shown and need not be contiguous, that is, other steps can be intermediate. According to this embodiment, accessing a digital living network alliance (DLNA) compatible peripheral device from a remote network includes the following steps:

Step 700: Serve web pages to a remote user through an external network connection utilizing a web server module.

Step 702: Control the digital living network alliance (DLNA) compatible peripheral device according to commands received from the remote user via the web pages served to the remote user.

Step 704: Pass a status of the digital living network alliance (DLNA) compatible peripheral device to the web server module for transfer to the remote user.

The present invention discloses a network gateway 500 allowing web based access to a plurality of Digital Living Network Alliance (DLNA) enabled peripheral devices 510, 512, 514 that are coupled to the network gateway 500. Because the gateway includes a web server, the user can control the DLNA peripheral devices from anywhere on the Internet from any device that supports web browsing capabilities. User authentication is performed by the web server 502 and the traffic can be encrypted using standard https. In this way, the network gateway according to the present invention is an appliance which aggregates all available services of DLNA enabled devices 510, 512, 514 coupled to the gateway 500 into a list, and presents the list in a web page format 600 with links to the available services. Port redirection can be implemented to then allow direct control of the 510, 512, 514 devices, or the web server 502 can act as an access proxy by generating web pages that allow the user 560 to access the devices 510, 512, 514. To ensure the user can always locate the gateway 500, a DDNS unit 506 periodically checks the current IP address of the gateway 500 and updates a DDNS server 552 accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network gateway comprising:
a first port being coupled to an external network connection;
a web server module being coupled to the first port for serving web pages to a remote user through the external network connection;
a digital living network alliance (DLNA) controller being coupled to the web server module; and
a second port being coupled to the digital living network alliance (DLNA) controller and a digital living network alliance (DLNA) compatible internal network;
wherein the digital living network alliance (DLNA) controller is for controlling a digital living network alliance (DLNA) compatible peripheral device being coupled to the network gateway utilizing the second port according to commands received from the remote user.

2. The network gateway of claim 1, wherein the web server module is further for performing a port redirect of an incoming port utilized by the web server to communicate with the remote user to another port for use controlling the digital living network alliance (DLNA) compatible peripheral device.

3. The network gateway of claim 1, wherein the digital living network alliance (DLNA) controller is further for passing a status of the digital living network alliance (DLNA) compatible peripheral device to the web server for display on the web pages to the remote user.

4. The network gateway of claim 3, wherein the web server is for serving hypertext markup language (HTML) web pages to the remote user through the external network connection according to the hypertext transfer protocol (HTTP).

5. The network gateway of claim 4, wherein the web server is further for serving the HTML web pages to the remote user through a predetermined transmission control protocol (TCP) port number of the external network connection.

6. The network gateway of claim 5, wherein the web server is further for performing user authentication to ensure the remote user is authorized to access the digital living network alliance (DLNA) compatible peripheral device.

7. The network gateway of claim 6, wherein the web server further includes a plurality of remote user names and corresponding passwords, each remote user name having a predetermined authorization level allowing access of a predetermined digital living network alliance (DLNA) compatible peripheral device.

8. The network gateway of claim 5, further comprising an internet protocol (IP) address monitor being coupled to the web server and the first port for periodically detecting an internet protocol (IP) address of the network gateway on the external network connection and reporting the detected IP address to a dynamic domain name server utilizing the external network connection.

9. The network gateway of claim 1, wherein the digital living network alliance (DLNA) controller is further for controlling a plurality of digital living network alliance (DLNA) compatible peripheral devices being coupled to the network gateway utilizing the second port according to the commands received from the remote user, and for passing statuses of the digital living network alliance (DLNA) compatible peripheral devices to the web server for display on the web pages to the remote user.

10. The network gateway of claim 9, wherein the digital living network alliance (DLNA) controller is further for automatically detecting which digital living network alliance (DLNA) compatible peripheral devices are coupled to the network gateway on the second port.

11. The network gateway of claim 9, wherein the web server is further for displaying a menu system on the web pages allowing the remote user to control and view statuses of each of the digital living network alliance (DLNA) compatible peripheral devices being coupled to the network gateway on the second port.

12. The network gateway of claim 1, wherein the web server is a hardware based web page serving module.

13. A method of accessing a digital living network alliance (DLNA) compatible peripheral device from a remote network, the method comprising:
serving web pages to a remote user through an external network connection utilizing a web server module;
controlling the digital living network alliance (DLNA) compatible peripheral device according to commands received from the remote user via the web pages served to the remote user; and
passing a status of the digital living network alliance (DLNA) compatible peripheral device to the web server module for transfer to the remote user.

14. The method of claim 13, further comprising performing a port redirect of an incoming port utilized by the web server to communicate with the remote user to another port for use controlling the digital living network alliance (DLNA) compatible peripheral device.

15. The method of claim 13, further comprising passing a status of the digital living network alliance (DLNA) compatible peripheral device to the web server for display on the web pages to the remote user.

16. The method of claim 15, further comprising serving hypertext markup language (HTML) web pages to the remote user through the external network connection according to the hypertext transfer protocol (HTTP).

17. The method of claim 16, further comprising serving the hypertext markup language (HTML) web pages to the remote user through a predetermined transmission control protocol (TCP) port number of the external network connection.

18. The method of claim 17, further comprising performing user authentication to ensure the remote user is authorized to access the digital living network alliance (DLNA) compatible peripheral device.

19. The method of claim 17, wherein the web server further includes a plurality of remote user names and corresponding passwords, each remote user name having a predetermined authorization level allowing access of a predetermined digital living network alliance (DLNA) compatible peripheral device.

20. The method of claim 17, further comprising periodically detecting an internet protocol (IP) address on the external network connection and reporting the detected IP address to a dynamic domain name server utilizing the external network connection.

21. The method of claim 15, further comprising:
controlling a plurality of digital living network alliance (DLNA) compatible peripheral devices according to the commands received from the remote user via the web pages served to the remote user; and
passing statuses of the digital living network alliance (DLNA) compatible peripheral devices to the web server for display on the web pages to the remote user.

22. The method of claim 21, further comprising automatically detecting which digital living network alliance (DLNA) compatible peripheral devices are accessible.

23. The method of claim 21, further comprising displaying a menu system on the web pages allowing the remote user to control and view statuses of each of the accessible digital living network alliance (DLNA) compatible peripheral devices.

24. The method of claim 13, wherein the web server is a hardware based web page serving module.
